(19) United States
(12) Patent Application Publication
(10) Pub. No.: US 2025/0212253 A1
(43) Pub. Date: Jun. 26, 2025

(54) CHANNEL USAGE CONTROL FOR NON-WIFI COMMUNICATIONS

(71) Applicant: Cisco Technology, Inc., San Jose, CA (US)

(72) Inventors: Matthew A. SILVERMAN, Shaker Heights, OH (US); Brian D. HART, Sunnyvale, CA (US); Malcolm M. SMITH, Richardson, TX (US); Binita GUPTA, San Diego, CA (US); John M. SWARTZ, Lithia, FL (US)

(21) Appl. No.: 18/600,286

(22) Filed: Mar. 8, 2024

Related U.S. Application Data
(60) Provisional application No. 63/614,522, filed on Dec. 22, 2023.

(51) Int. Cl. H04W 74/0816; H04W 74/04; H04W 74/08; H04W 84/12

(52) U.S. Cl. CPC H04W 74/0816; H04W 74/04; H04W 74/0866; H04W 84/12

(57) ABSTRACT

The present disclosure describes a network that allows a device to request that an access point refrain from transmitting WiFi messages for a period of time to allow the device to transmit non-WiFi messages. An access point includes one or more memories and one or more processors communicatively coupled to the one or more memories. A combination of the one or more processors receives, from a first device, a request to refrain from transmitting WiFi messages to the first device during a time period, communicates, to the first device, a response confirming that the access point will refrain from transmitting WiFi messages to the first device during the time period, and refrains from transmitting the WiFi messages to the first device during the time period.

### CROSS-REFERENCE TO RELATED APPLICATIONS

This application claims benefit of co-pending U.S. provisional patent application Ser. No. 63/614,522 filed Dec. 22, 2023. The aforementioned related patent application is herein incorporated by reference in its entirety.

### TECHNICAL FIELD

Embodiments presented in this disclosure generally relate to wireless communications. More specifically, embodiments disclosed herein relate to controlling channel usage to allow for non-wireless fidelity (WiFi) communications.

### BACKGROUND

Multiple types of wireless devices may attempt to communicate in a space. For example, WiFi devices, Bluetooth devices, ultra wideband (UWB) devices, and devices using other protocols may attempt to communicate at the same time. In some instances, a device may communicate using multiple of these protocols. These different communications, however, may cause collisions, conflicts, and interference, which degrades communication quality.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIGS. 1A and 1B illustrate an example system.

FIG. 2 illustrates an example operation performed by the system of FIG. 1A.

FIG. 3 illustrates example messages in the system of FIG. 1A.

FIG. 4 illustrates an example operation performed by the system of FIG. 1A.

FIGS. 5A through 5D illustrate an example operation performed by the system of FIG. 1A.

FIG. 6 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a network that allows a device to request that an access point refrain from transmitting WiFi messages for a period of time to allow the device to transmit non-WiFi messages. According to an embodiment, an access point includes one or more memories and one or more processors communicatively coupled to the one or more memories. A combination of the one or more processors receives, from a first device, a request to refrain from transmitting WiFi messages to the first device during a time period, communicates, to the first device, a response confirming that the access point will refrain from transmitting WiFi messages to the first device during the time period, and refrains from transmitting the WiFi messages to the first device during the time period.

According to another embodiment, a method includes receiving, by an access point and from a first device, a request to refrain from transmitting WiFi messages to the first device during a time period, communicating, to the first device, a response confirming that the access point will refrain from transmitting WiFi messages to the first device during the time period, and refraining from transmitting the WiFi messages to the first device during the time period.

According to another embodiment, a non-transitory computer readable medium stores instructions that, when executed by a combination of one or more processors, cause the combination of one or more processors to receive, from a first device, a Channel Usage Request frame indicating that the first device is unavailable for WiFi messages during a time period and refrain from transmitting the WiFi messages to the first device during the time period.

### Example Embodiments

The present disclosure describes a wireless network (e.g., a WiFi network) in which access points allow devices to request that the access points refrain from transmitting WiFi messages for a period of time so that the devices can transmit non-WiFi messages (e.g., Bluetooth messages, UWB messages, etc.). A device communicates a request (e.g., a channel usage request frame) to an access point to request that the access point refrain from transmitting WiFi messages for a period of time. The access point responds with a channel usage response frame to confirm that the access point will not transmit the WiFi messages during the period of time. When the period of time begins, the access point refrains from transmitting the WiFi messages. In some embodiments, the access point refrains transmitting the WiFi messages only to the requesting device. In other embodiments, the access point refrains from transmitting WiFi messages to multiple devices during the period of time.

In particular embodiments, the network provides several technical advantages. For example, the network allows non-WiFi messages to be transmitted with fewer collisions and conflicts. As another example, the network allows non-WiFi messages to be transmitted with less interference. As a result, the network coordinates WiFi messages to provide better communication quality for non-WiFi messages.

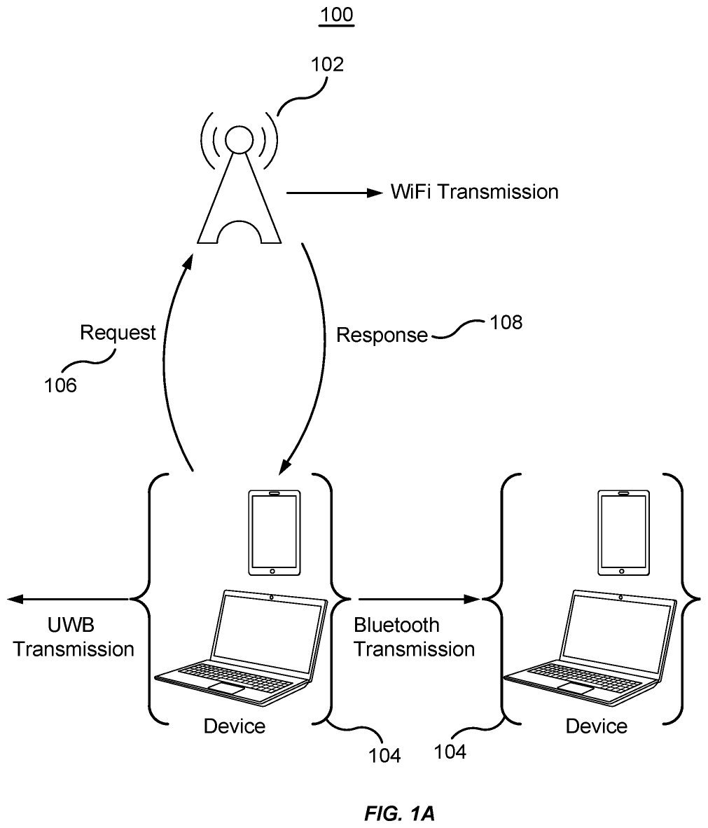

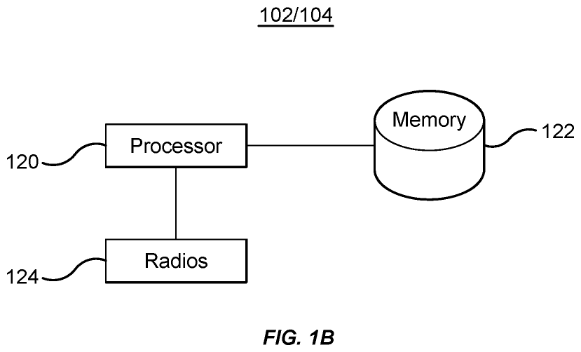

FIG. 1A illustrates an example system 100, which may be a wireless network (e.g., a WiFi network). As seen in FIG. 1A, the system 100 includes one or more access points 102 and one or more devices 104. Generally, the devices 104 connect to an access point 102. The access point 102 provides network coverage for the system 100. The access point 102 communicates messages (e.g., WiFi messages) to the devices 104 and directs messages from the devices 104 towards their destination.

The access point 102 facilitates wireless communication (e.g., WiFi communication) in the system 100. One or more devices 104 may connect to the access point 102. The access point 102 may then facilitate wireless communication for the connected devices 104. For example, the access point 102 may transmit messages to a connected device 104. As another example, the access point 102 may receive messages transmitted by the device 104. The access point 102 may then direct that message towards its intended destination.

The device 104 may be any suitable device that wirelessly connects to the access point 102. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user. The device 104 may include a hardware processor, memory, or circuitry configured to perform any of the functions or actions of the device 104 described herein. For example, a software application designed using software code may be stored in the memory and executed by the processor to perform the functions of the device 104.

The device 104 may transmit non-WiFi messages using radios other than WiFi radios. For example, the device 104 may include one or more Bluetooth radios that the device 104 uses to transmit and receive Bluetooth messages. As another example, the device 104 may include UWB radios that the device 104 uses to transmit and receive UWB messages. These non-WiFi messages, however, may cause collisions, conflicts, and interference with WiFi messages, which degrades communication quality. For example, if the access point 102 is transmitting a WiFi message to the device 104 when the device 104 is transmitting a Bluetooth message and/or UWB message, the WiFi message, Bluetooth message, and/or UWB message may not reach their intended destinations correctly.

The access point 102 and device 104 may perform a process to coordinate the transmissions of WiFi and non-WiFi messages to reduce the collisions, conflicts, and interference. Generally, when the device 104 anticipates that the device 104 will transmit a non-WiFi message, the device 104 communicates a request 106 (e.g., a channel usage request frame) to the access point 102 to request that the access point 102 stop transmitting WiFi messages (e.g., to the device 104) during a particular time period when the device 104 anticipates that the device 104 will transmit non-WiFi messages. The access point 102 may then schedule WiFi transmissions (e.g., to the device 104 and/or to another device 104) to avoid that time period. The access point 102 communicates a response 108 (e.g., a channel usage response frame) to the device 104 to confirm that the access point 102 will avoid transmitting WiFi messages (e.g., to the device 104 and/or to another device 104) during the time period. The device 104 may then transmit non-WiFi messages during that time period.

FIG. 1B illustrates an example access point 102 or device 104 in the system 100 of FIG. 1A. As seen in FIG. 1B, the access point 102 or device 104 includes a processor 120, a memory 122, and one or more radios 124.

The processor 120 is any electronic circuitry, including, but not limited to one or a combination of microprocessors, microcontrollers, application specific integrated circuits (ASIC), application specific instruction set processor (ASIP), and/or state machines, that communicatively couples to the memory 122 and controls the operation of the access point 102 and/or device 104. The processor 120 may be 8-bit, 16-bit, 32-bit, 64-bit or of any other suitable architecture. The processor 120 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 120 may include other hardware that operates software to control and process information. The processor 120 executes software stored on the memory 122 to perform any of the functions described herein. The processor 120 controls the operation and administration of the access point 102 and/or device 104 by processing information (e.g., information received from the memory 122 and radios 124). The processor 120 is not limited to a single processing device and may encompass multiple processing devices contained in the same device or computer or distributed across multiple devices or computers. The processor 120 is considered to perform a set of functions or actions if the multiple processing devices collectively perform the set of functions or actions, even if different processing devices perform different functions or actions in the set.

The memory 122 may store, either permanently or temporarily, data, operational software, or other information for the processor 120. The memory 122 may include any one or a combination of volatile or non-volatile local or remote devices suitable for storing information. For example, the memory 122 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 122, a disk, a CD, or a flash drive. In particular embodiments, the software may include an application executable by the processor 120 to perform one or more of the functions described herein. The memory 122 is not limited to a single memory and may encompass multiple memories contained in the same device or computer or distributed across multiple devices or computers. The memory 122 is considered to store a set of data, operational software, or information if the multiple memories collectively store the set of data, operational software, or information, even if different memories store different portions of the data, operational software, or information in the set.

The radios 124 may communicate messages or information using different communication technologies. For example, the access point 102 and/or device 104 may use one or more of the radios 124 for WiFi communications. The access point 102 and/or device 104 may use one or more of the radios 124 to transmit messages and one or more of the radios 124 to receive messages. The access point 102 and/or device 104 may include any number of radios 124 to communicate using any number of communication technologies. The device 104 may use one or more of the radios 124 for non-WiFi communications (e.g., Bluetooth communications, UWB communications, etc.).

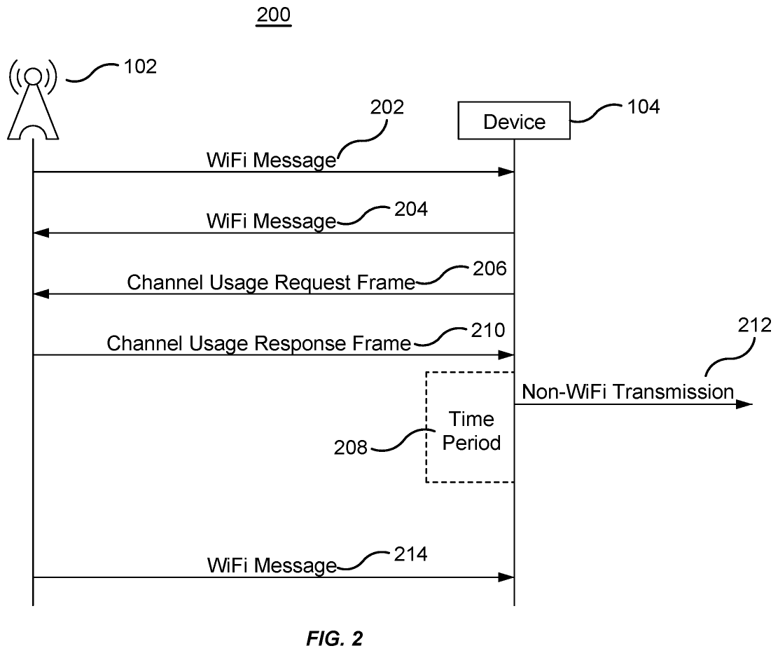

FIG. 2 illustrates an example operation 200 performed by the system 100 of FIG. 1A. As seen in FIG. 2, the access point 102 and the device 104 perform the operation 200. By performing the operation 200, the access point 102 and the device 104 coordinate WiFi and non-WiFi transmissions.

The access point 102 and the device 104 may communicate WiFi messages with each other. For example, the access point 102 may communicate a WiFi message 202 to the device 104. Additionally, the device 104 may communicate a WiFi message 204 to the access point 102. In this manner, the access point 102 and the device 104 engage in WiFi communications with each other.

When the device 104 anticipates that the device 104 will make a non-WiFi transmission, the device 104 initiates a process with the access point 102 to coordinate the WiFi communications between the access point 102 and the device 104 to reduce collisions, conflicts, and interference with the non-WiFi transmission. The device 104 may begin by communicating a channel usage request frame 206 to the access point 102. The channel usage request frame 206 may be the request 106. The channel usage request frame 206 may indicate a time period 208 when the device 104 anticipates that non-WiFi transmissions may occur. The access point 102 receives the channel usage request frame 206 and learns of the time period 208. The access point 102 may then schedule WiFi transmissions to avoid communicating WiFi messages to the device 104 during the time period 208 indicated in the channel usage request frame 206. The access point 102 then communicates a channel usage response frame 210 to the device 104 to confirm that the access point 102 will refrain from transmitting WiFi messages to the device 104 during the time period 208. The channel usage response frame 210 may be the response 108. The channel usage response frame 210 may indicate the time period 208 indicated in the channel usage request frame 206 to confirm that the access point 102 will refrain from transmitting WiFi messages to the device 104 during the time period 208.

When the time period 208 occurs, the device 104 makes a non-WiFi transmission 212. For example, the device 104 may make a Bluetooth transmission and/or a UWB transmission. The access point 102 may refrain from transmitting WiFi messages to the device 104 during the time period 208. After the time period 208 expires, the access point 102 may begin transmitting WiFi messages to the device 104. For example, the access point 102 may transmit a WiFi message 214 to the device 104. In this manner, the access point 102 reduces collisions, conflicts, and interference with the non-WiFi transmission 212.

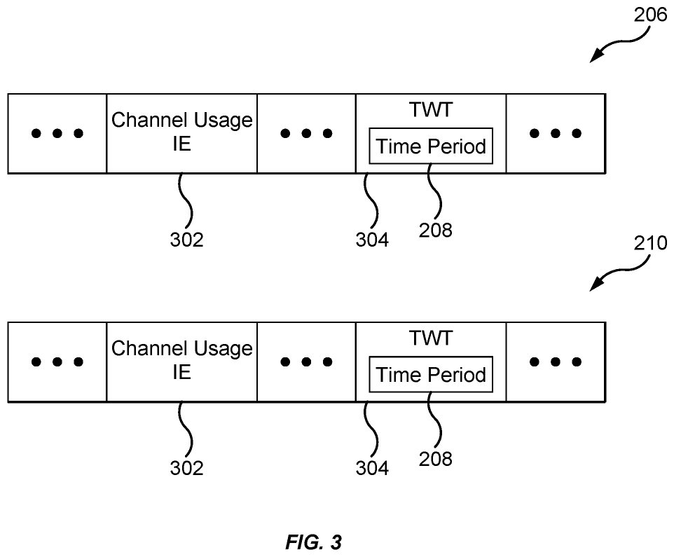

FIG. 3 illustrates example messages in the system 100 of FIG. 1A. Specifically, FIG. 3 illustrates an example channel usage request frame 206 and an example channel usage response frame 210.

The device 104 may send the channel usage request frame 206 when the device 104 anticipates that the device 104 will make non-WiFi transmissions. As seen in FIG. 3, the channel usage request frame 206 includes a channel usage information element 302, and a target wake time (TWT) element 304. The channel usage information element 302 indicates that the message pertains to usage of the channel between the access point 102 and the device 104. The TWT element 304 indicates the time period 208. As a result, the channel usage request frame 206 requests that the access point 102 refrain from transmitting WiFi messages to the device 104 during the time period 208. The channel usage request frame 206 may include other elements not shown in FIG. 3.

The access point 102 may communicate the channel usage response frame 210 to the device 104 to confirm that the access point 102 will refrain from transmitting WiFi messages to the device 104 during the time period 208. As seen in FIG. 3, the channel usage response frame 210 includes the channel usage information element 302 and the TWT element 304. Additionally, the TWT element 304 indicates the time period 208. The time period 208 indicated in the channel usage response frame 210 may be the same time period 208 indicated in channel usage request frame 206. In this manner, the access point 102 confirms to the device 104 that the access point 102 will refrain from transmitting WiFi messages to the device 104 during the time period 208. The channel usage response frame 210 may include other elements not shown in FIG. 3.

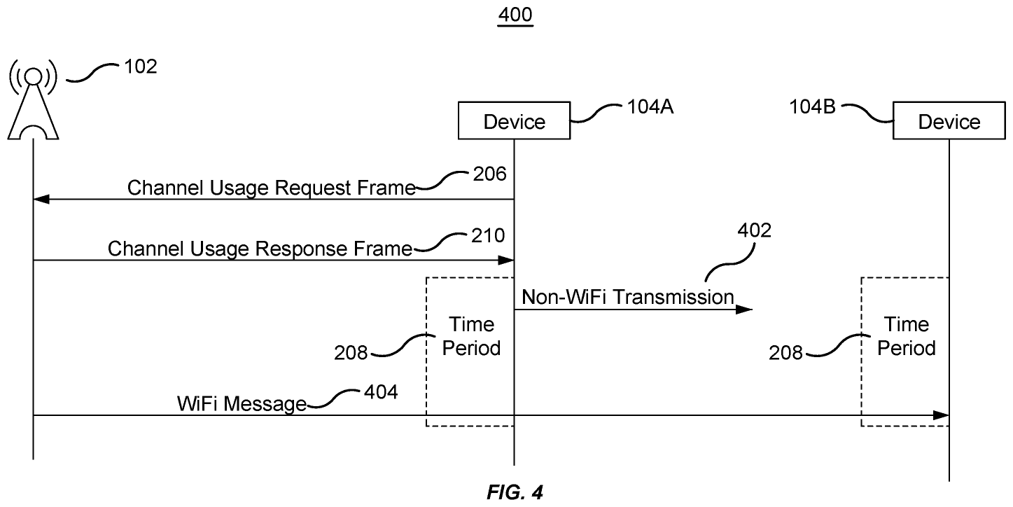

FIG. 4 illustrates an example operation 400 performed by the system 100 of FIG. 1A. Generally, the access point 102 and multiple devices 104 perform the operation 400. By performing the operation 400, the access point 102 may transmit WiFi messages to other devices 104 during the time period 208.

As seen in FIG. 4, the device 104A and the device 104B may be in communication with the access point 102. The device 104A may anticipate that the device 104A will make non-WiFi transmissions during the time period 208. The device 104A communicates the channel usage request frame 206 to the access point 102 to request that the access point 102 refrain from making WiFi transmissions to the device 104A during the time period 208. The access point 102 confirms that the access point 102 will refrain from transmitting WiFi messages to the device 104A during the time period 208 by communicating the channel usage response frame 210 to the device 104A.

During the time period 208, the device 104A makes a non-WiFi transmission 402 (e.g., a Bluetooth transmission or a UWB transmission). The access point 102 may not refrain from transmitting WiFi messages altogether during the time period 208. As seen in FIG. 4, the access point 102 may transmit a WiFi message 404 to the device 104B during the time period 208. The device 104B may not make a non-WiFi transmission during the time period 208. The device 104B may also make a WiFi transmission to the access point 102 during the time period 208. As a result, the WiFi message 404 may not encounter collisions, conflicts, and/or interference from the device 104B during the time period 208. In this manner, the access point 102 may more efficiently use communication resources during the time period 208.

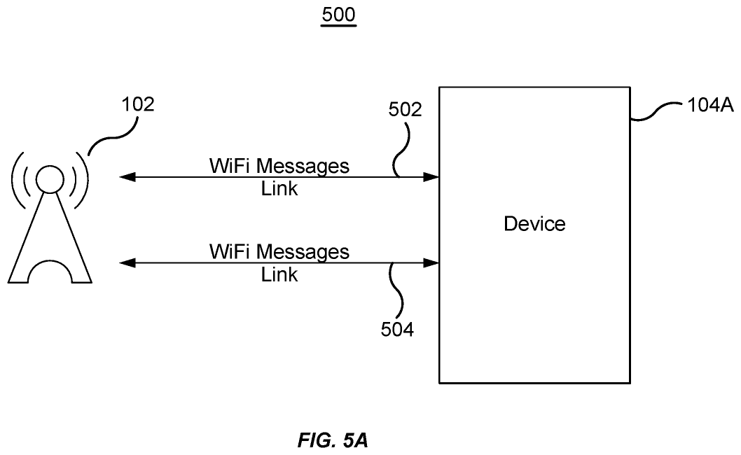

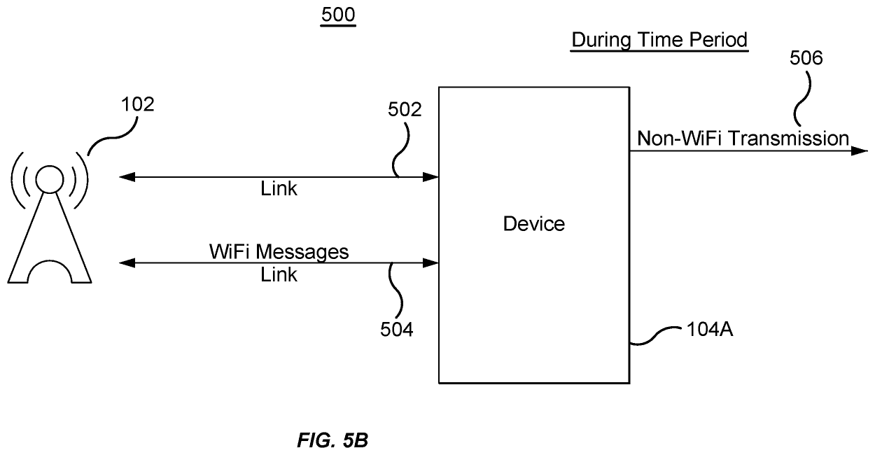

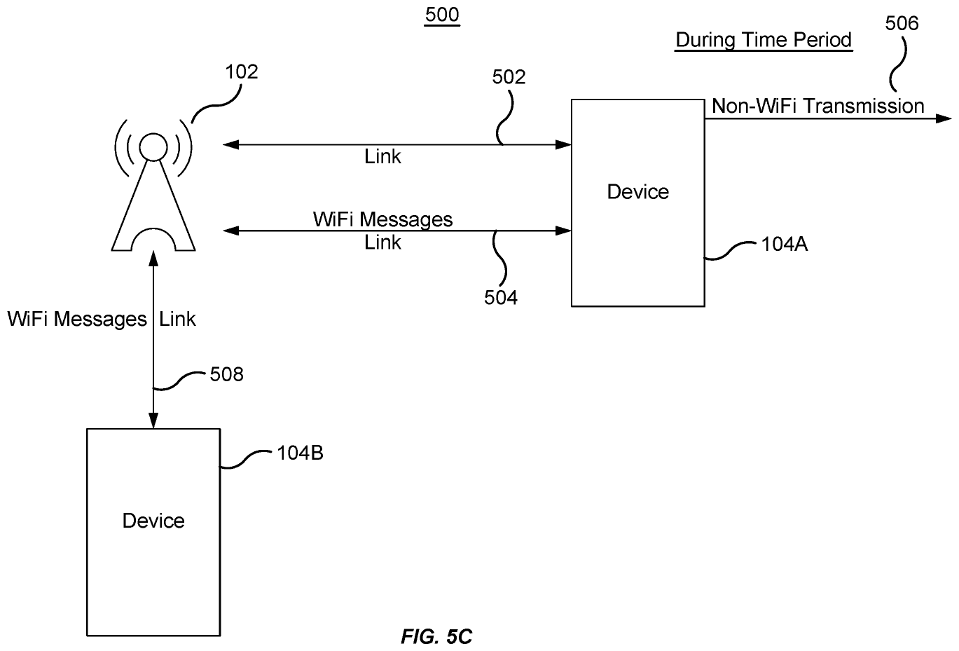

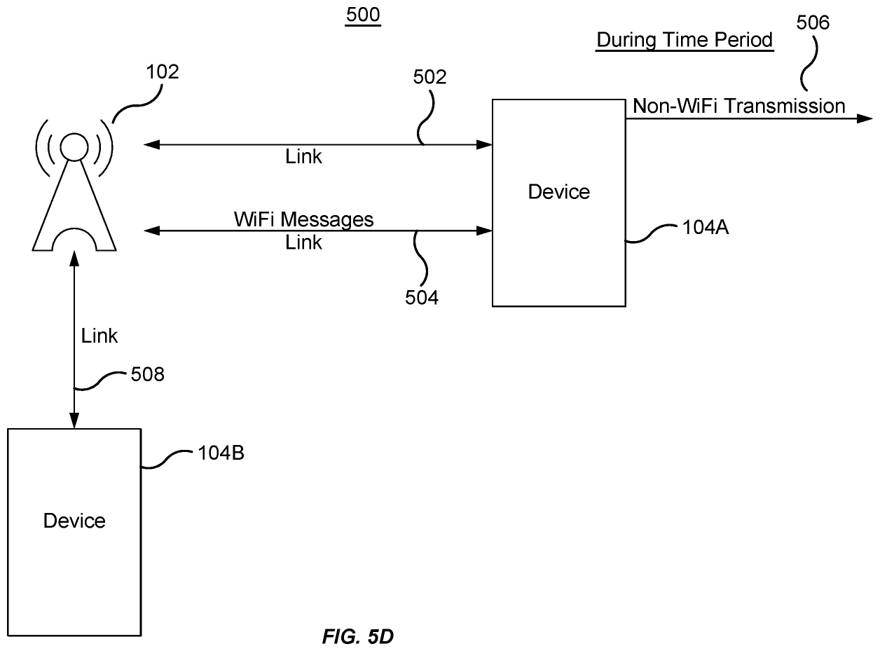

FIGS. 5A through 5D illustrate an example operation 500 performed by the system 100 of FIG. 1A. Generally, the operation 500 may be performed when the access point 102 and/or the device 104 support multi-link operation. As seen in FIG. 5A, the access point 102 and the device 104A may communicate over multiple links 502 and 504. Specifically, the access point 102 and the device 104A may communicate WiFi messages to each other over the link 502 and over the link 504. The links 502 and 504 may be in separate frequency domains. For example, the link 502 may be in the 2.4 gigahertz (GHz) or 5 GHz domain, and the link 504 may be in the 5 GHz or 6 GHz domain.

As seen in FIG. 5B, during the time period the device 104A may make a non-WiFi transmission 506. The access point 102 may refrain from transmitting WiFi messages over one of the links 502 supported by the access point 102 and the device 104A. The access point 102 may continue transmitting WiFi messages to the device 104A over a separate link 504. Because the link 504 may be in a separate frequency domain than the link 502, WiFi messages transmitted over the link 504 may not cause as much collisions, conflicts, or interference with the non-WiFi transmission 506. As a result, the access point 102 may continue transmitting WiFi messages to the device 104A during the time period, but on a separate link 504 than the link 502 over which the access point 102 refrains from transmitting WiFi messages. In effect, refraining from transmitting WiFi messages to the device 104A during the time period is limited to refraining from transmitting WiFi messages to the device 104A over the link 502. The access point 102 may continue transmitting WiFi messages to the device 104A over the link 504.

During the time period when the device 104A can make the non-WiFi transmission 506, the access point 102 may also schedule WiFi messages to be transmitted to other devices 104. As seen in FIG. 5C, the access point 102 refrains from transmitting WiFi messages to the device 104A over the link 502 during the time period when the device 104A can make the non-WiFi transmission 506. Additionally, the access point 102 may transmit WiFi messages to another device 104B over a link 508 between the access point 102 and the device 104B. The link 508 may be in the same frequency domain as the link 502. As a result, as seen in FIG. 5C, although the access point 102 refrains from transmitting WiFi messages to the device 104A over the link 502, the access point 102 may continue transmitting WiFi messages over the link 508 to the device 104B even though the links 502 and 508 are in the same frequency domain. In this manner, the access point 102 more efficiently uses network resources during the time period when the access point 102 refrains from transmitting WiFi messages to the device 104A over the link 502.

In certain instances, the access point 102 may refrain from transmitting WiFi messages to other devices 104 during the time period. As seen in FIG. 5D, during the time period, the access point 102 refrains from transmitting WiFi messages to the device 104A over the link 502 to reduce collisions, conflicts, and interference with the non-WiFi transmission 506 made by the device 104A. Additionally, the access point 102 refrains from transmitting WiFi messages to the device 104B over the link 508. The link 508 may be in the same frequency domain as the link 502. In this manner, the access point 102 may further reduce collisions, conflicts, and interference for the non-WiFi transmission 506.

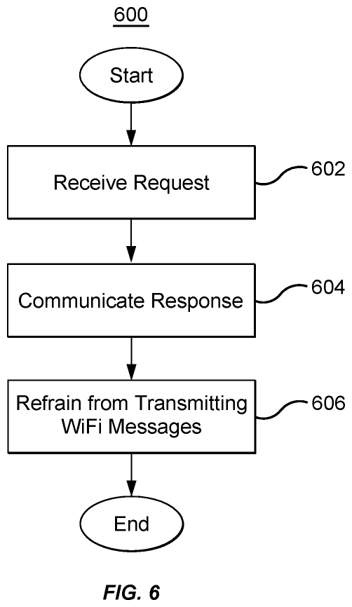

FIG. 6 is a flowchart of an example method 600 performed by the system 100 of FIG. 1A. In particular embodiments, the access point 102 performs the method 600. By performing the method 600, the access point 102 reduces collisions, conflicts, and interference with non-WiFi transmissions in the system 100.

In block 602, the access point 102 receives a request 106 from a device 104. The request 106 may be the channel usage request frame 206. The channel usage request frame 206 may include the TWT element 304 that indicates the time period 208. As a result, the channel usage request frame 206 may request that the access point 102 refrain from transmitting WiFi messages to the device 104 during the time period 208.

In block 604, the access point 102 communicates the response 108 to the device 104. The response 108 may be the channel usage response frame 210. The channel usage response frame 210 may include the TWT element 304, which indicates the time period 208. The access point 102 may confirm, through the response 108, that the access point 102 will refrain from transmitting WiFi messages to the device 104 during the time period 208. The access point 102 may instead schedule these WiFi messages to be transmitted outside the time period 208.

In block 606, the access point 102 refrains from transmitting WiFi messages to the device 104 during the time period 208. For example, the access point 102 may schedule these WiFi messages to be transmitted outside the time period 208. If the access point 102 and the device 104 communicate over multiple links, then the access point 102 may refrain from transmitting WiFi messages over one of the links, while continuing to transmit WiFi messages to the device 104 over the other link. In this manner, the access point 102 reduces collisions, conflicts, and interference with non-WiFi transmissions made by the device 104 during the time period 208.

In summary, the access point 102 allows the device 104 to request that the access point 102 refrain from transmitting WiFi messages for a period of time so that the device 104 can transmit non-WiFi messages (e.g., Bluetooth messages, UWB messages, etc.). The device 104 communicates a request (e.g., a channel usage request frame) to the access point 102 to request that the access point 102 refrain from transmitting WiFi messages for a period of time. The access point 102 responds with a channel usage response frame to confirm that the access point 102 will not transmit the WiFi messages during the period of time. When the period of time begins, the access point 102 refrains from transmitting the WiFi messages. In some embodiments, the access point 102 refrains transmitting the WiFi messages only to the requesting device 104. In other embodiments, the access point 102 refrains from transmitting WiFi messages to multiple devices 104 during the period of time. In multi-link implementations, the access point 102 may refrain from transmitting WiFi messages to the device 104 over a link during the period of time, but the access point 102 may continue transmitting WiFi messages to the device 104 during the period of time over another link.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point comprising:
one or more memories; and
one or more processors communicatively coupled to the one or more memories, a combination of the one or more processors configured to:
receive, from a first device, a request to refrain from transmitting wireless fidelity (WiFi) messages to the first device during a time period;
communicate, to the first device, a response confirming that the access point will refrain from transmitting WiFi messages to the first device during the time period; and
refrain from transmitting the WiFi messages to the first device during the time period.

2. The access point of claim 1, wherein the request comprises a target wake time (TWT) element specifying the time period.

3. The access point of claim 2, wherein the response comprises the TWT element specifying the time period.

4. The access point of claim 1, wherein the combination of the one or more processors is further configured to schedule a transmission to a second device for the time period.

5. The access point of claim 1, wherein the first device has established a first link and a second link with the access point and wherein refraining from transmitting the WiFi messages to the first device during the time period is limited to refraining from transmitting the WiFi messages to the first device over the first link.

6. The access point of claim 5, wherein the combination of the one or more processors is further configured to transmit the WiFi messages to the first device over the second link during the time period.

7. The access point of claim 6, wherein the combination of the one or more processors is further configured to transmit WiFi messages to a second device over a third link during the time period, wherein the first link and the third link are in a same frequency domain.

8. The access point of claim 1, wherein the combination of the one or more processors is further configured to refrain from transmitting WiFi messages to a second device during the time period.

9. A method comprising:
receiving, by an access point and from a first device, a request to refrain from transmitting WiFi messages to the first device during a time period;
communicating, to the first device, a response confirming that the access point will refrain from transmitting WiFi messages to the first device during the time period; and
refraining from transmitting the WiFi messages to the first device during the time period.

10. The method of claim 9, wherein the request comprises a TWT element specifying the time period.

11. The method of claim 10, wherein the response comprises the TWT element specifying the time period.

12. The method of claim 9, further comprising schedule a transmission to a second device for the time period.

13. The method of claim 9, wherein the first device has established a first link and a second link with the access point and wherein refraining from transmitting the WiFi messages to the first device during the time period is limited to refraining from transmitting the WiFi messages to the first device over the first link.

14. The method of claim 13, further comprising transmitting the WiFi messages to the first device over the second link during the time period.

15. The method of claim 14, further comprising transmitting WiFi messages to a second device over a third link during the time period, wherein the first link and the third link are in a same frequency domain.

16. The method of claim 9, further comprising refraining from transmitting WiFi messages to a second device during the time period.

17. A non-transitory computer readable medium storing instructions that, when executed by a combination of one or more processors, cause the combination of one or more processors to:
receive, from a first device, a Channel Usage Request frame indicating that the first device is unavailable for WiFi messages during a time period; and
refrain from transmitting the WiFi messages to the first device during the time period.

18. The medium of claim 17, wherein the Channel Usage Request frame comprises a TWT element specifying the time period.

19. The medium of claim 18, wherein the instructions further cause the combination of one or more processors to transmit a Channel Usage Response frame in response to the Channel Usage Request frame, wherein the Channel Usage Response frame comprises the TWT element.

20. The medium of claim 17, wherein the instructions further cause the combination of one or more processors to schedule a transmission to a second device for the time period.
